(19) United States
(12) Patent Application Publication
(10) Pub. No.: US 2015/0226416 A1
(43) Pub. Date: Aug. 13, 2015

(54) High Power LED Lighting Fixture

(71) Applicant: Frank Tsao, Dong Guan (CN)

(72) Inventor: Frank Tsao, Dong Guan (CN)

(73) Assignee: CASTER LIGHTING INC., New Taipei City (TW)

(21) Appl. No.: 14/695,485

(22) Filed: Apr. 24, 2015

(30) Foreign Application Priority Data
Nov. 19, 2014 (CN) 201420693067.3

(51) Int. Cl. F21V 29/10; F21V 19/00; F21V 29/15

(52) U.S. Cl. CPC F21V 29/10; F21V 29/15; F21V 19/006; F21Y 2101/02

(57) ABSTRACT

What is disclosed is a high power LED lighting fixture. It includes a light source enclosure for holding a LED lighting component and an electric enclosure for holding a power supply component; a front end of the electric enclosure being connected to a distal end of the light source enclosure, a heat isolation gap is defined between a front end surface of the electric enclosure and a distal end surface of the light source enclosure. The electric enclosure and light source enclosure are designed separately. A heat isolation gap is provided between the connection location of the electric enclosure and light source enclosure, thus increasing thermal resistance and reducing heat transfer between the power supply component and LED lighting component.

### FIELD OF THE INVENTION

The present invention relates to a high power LED lighting fixture and more particularly, relates to high power LED lighting fixture.

### BACKGROUND OF THE INVENTION

As a new kind of lighting source featuring energy saving and environment protection, LED has been widely used in various lighting fixtures such as street lighting fixture, sight lighting fixture and the like. When in operation, LED itself requires good cooling, thus maintaining normal and high effective operation. As such, it is necessary for a lighting fixture especially LED lighting fixture with high power to have good heat dissipation. LED lighting fixture generates much heat during working because of its high power. Therefore design of heat dissipation mechanism is significantly important for high power LED lighting fixture.

It is well known in LED lighting industry that a high power LED lighting fixture generally includes two components one of which is intended for location of a LED light source while the other one of which is used for installation of a power supply. These two components are integrally formed. For a high power LED lighting fixture, a power supply is also an important heat generating component in addition to LED light source. Moreover heat generated by the power supply and LED light source may have bad influence on each other. Like radiated of concentration, propagation of heat happens from the highest temperature point to the lowest temperature zone. As two heat sources on the same lighting fixture, LED light source and power supply coexist. Heat generated by the power supply and LED light source may have bad influence on each other. To reduce mutual influence of two heat sources, sufficient space gap is needed between LED light source and power supply of a conventional high power LED lighting fixture in order to reduce mutual influence. The higher the power of LED is, the bigger the gap will be. Though this method can reduce mutual impact between LED light source and power supply to certain extent, under this circumstance this is necessary to increase in size of high power LED outdoor lighting fixture. Heavy lighting fixture body will limit application of high power LED lighting fixture and cause inconvenience in transportation and installation at the same.

### SUMMARY OF THE INVENTION

The present invention is to overcome drawbacks of prior art and provide a high power LED lighting fixture. LED light sources will be less influenced by heat generated from power supply through reducing heat transfer between power supply and LED light sources.

To this end, there is provided a solution as follows.

A high power LED lighting fixture includes a light source enclosure for holding a LED light sources and an electric enclosure for holding power supply. A front end of the electric enclosure is connected to end of the light source enclosure. A heat resistant effect is created between the electric enclosure and the LED light source enclosure.

The front end surface of the electric enclosure and distal end surface of the light source enclosure contact with each other by mounting means. The front end surface of the electric enclosure and/or distal end surface of the light source enclosure is an irregular surface. The gap formed between the front end surface of the electric enclosure and distal end surface of the light source enclosure is a heat isolation gap.

The front end surface of the electric enclosure and distal end surface of the light source enclosure are disposed such that a slot is defined there-between. The slot formed between the front end surface of the electric enclosure and distal end surface of the light source enclosure is a heat isolation slot.

An insulation sheet is disposed in the heat isolation gap.

One surface of the insulation sheet contacts the front end surface of the electric enclosure, while the other surface thereof contacts the distal end surface of the light source enclosure.

A groove is defined in the front end of the electric enclosure, and a protrusion is formed on the distal end of the light source enclosure. The protrusion is inserted into the groove so as to realize bayonet connection between the electric enclosure and light source enclosure.

A screw is placed between the front end surface of the electric enclosure and distal end surface of the light source enclosure. The screw passes through the front end surface of the electric enclosure and distal end of the light source enclosure and then locks the two together.

The screw may be a hollow metal screw.

In current invention, a conventional integral high power LED lighting fixture enclosure is divided into two separate portions: an electric enclosure and alight source enclosure. Furthermore, a heat isolation gap is provided between the connection location of the electric enclosure and light source enclosure. This heat isolation gap increases thermal resistance and effectively reduces heat transfer between LED lighting component and power supply component, thereby facilitating heat dissipation. Moreover, this portion-separated design also brings convenience in production and installation.

### BRIEF DESCRIPTION OF THE DRAWINGS

FIG. 1 shows a perspective view of the present invention;

FIG. 2 shows an exploded view of the present invention;

FIG. 3 shows a perspective view of a light source enclosure of the present invention;

FIG. 4 shows an enlarged view of portion A of FIG. 3;

FIG. 5 shows a perspective view of an electric enclosure of the present invention; and

FIG. 6 shows an enlarged view of portion B of FIG. 5.

### DETAILED DESCRIPTION OF THE INVENTION

To good understand the present invention, embodiments of the invention are described in conjunction with figures.

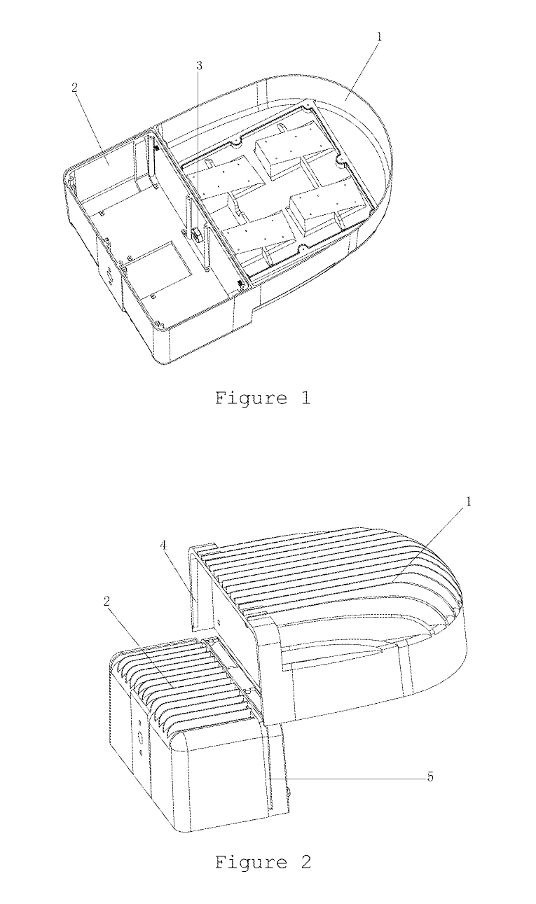

As shown in FIGS. 1-2, a high power LED lighting fixture includes a light source enclosure 1 for holding a LED lighting component and an electric enclosure 2 for holding a power supply component. A front end of the electric enclosure 2 is connected to a distal end of the light source enclosure 1. A heat isolation gap is defined between a front end surface of the electric enclosure 2 and a distal end surface of the light source enclosure 1 such that the front end surface of the electric enclosure 2 will not completely contacts the distal end of the light source enclosure 1, hence increasing thermal resistance. There are two preferred embodiments regarding this heat isolation gap.

According to a first embodiment, the front end surface of the electric enclosure 2 and distal end surface of the light source enclosure 1 contact with each other by mounting means. The front end surface of the electric enclosure 2 and distal end surface of the light source enclosure 1 are an irregular surface. In other words, the front end surface of the electric enclosure 2 and distal end surface of the light source enclosure 1 are of uneven surface such that when the front end surface of the electric enclosure 2 and distal end surface of the light source enclosure 1 are mounted with each other, a gap will be defined there-between due to uneven surfaces. This gap is a heat isolation gap. Alternatively, the front end surface of the electric enclosure may be configured to be irregular surface, while the distal end surface of the light source enclosure may be designed to be regular surface. Or, the front end surface of the electric enclosure may be configured to be regular surface, while the distal end surface of the light source enclosure may be designed to be irregular surface. In this situation, when the front end surface of the electric enclosure 2 and distal end surface of the light source enclosure 1 are mounted with each other, a heat isolation gap will be also defined there-between.

According to a second embodiment, a slot is formed between the front end surface of the electric enclosure 2 and distal end surface of the light source enclosure 1 and it is a heat isolation slot. In other words, the front end surface of the electric enclosure 2 and distal end surface of the light source enclosure not contact with each other. Regarding this construction, for facilitating fabrication, both the front end surface of the electric enclosure 2 and distal end surface of the light source enclosure 1 are designed to be regular surface. In addition, an insulation sheet (not shown) may be disposed inside the heat isolation slot. The insulation sheet is inserted into the heat isolation slot such that one surface of the insulation sheet contacts the front end surface of the electric enclosure, while the other surface thereof contacts the distal end surface of the light source enclosure. By this manner, thermal resistance is increased by the insulation sheet and transfer of heat is decreased.

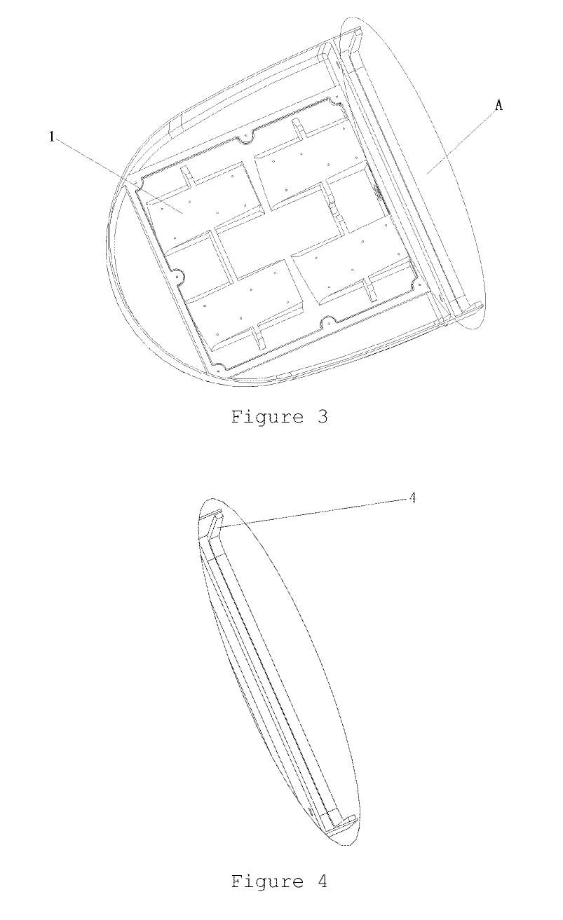

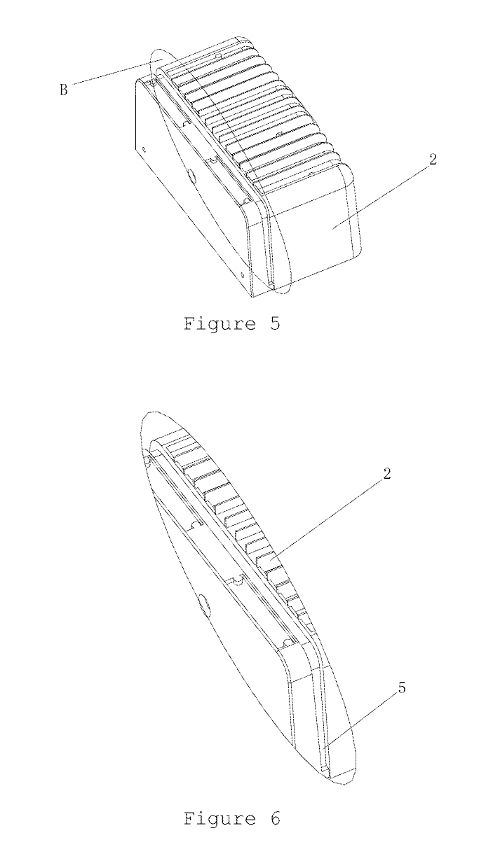

In addition, to facilitate installation, as shown in FIGS. 3-6, a groove 5 is defined in the front end of the electric enclosure 2, and a protrusion 4 is formed on the distal end of the light source enclosure 1. The protrusion 4 is inserted into the groove 5 so as to realize bayonet connection between the electric enclosure 2 and light source enclosure 1. In this embodiment, the groove may be of U-shaped, and correspondingly, the protrusion may be of an inverted U-shape. They can be mounted together by insertion of one into the other one, thus facilitating disassembling. To further realize fastening, a screw 3 is placed between the front end surface of the electric enclosure 2 and distal end surface of the light source enclosure 1. The screw 3 passes through the front end surface of the electric enclosure 1 and distal end of the light source enclosure 2 and then locks the two together. Preferably, the screw may be a hollow metal screw.

Furthermore, the electric enclosure and light source enclosure of the instant invention also includes cooling fins for radiating heat. As this is well known and out of the feature of the invention, description thereof is omitted. Specific construction and mounting of the LED lighting component and power supply component are also common to person of the art and they are also omitted.

It is noted that the above embodiments are not limitative to the solution of the present invention. External shapes of the product are also only exemplary and not limitative. According to actual situation flexible design may be made to them. Any obvious replacements are within the scope of the invention without departing from the spirit of the invention.

1. A high power LED lighting fixture comprising a light source enclosure for holding a LED lighting component and an electric enclosure for holding a power supply component; a front end of the electric enclosure being connected to a distal end of the light source enclosure, wherein a heat isolation gap is defined between a front end surface of the electric enclosure and a distal end surface of the light source enclosure.

2. The high power LED lighting fixture according to claim 1, wherein the front end surface of the electric enclosure and distal end surface of the light source enclosure contact with each other by mounting means; the front end surface of the electric enclosure and/or distal end surface of the light source enclosure is an irregular surface; and the gap formed between the front end surface of the electric enclosure and distal end surface of the light source enclosure is a heat isolation gap.

3. The high power LED lighting fixture according to claim 1, wherein the front end surface of the electric enclosure and distal end surface of the light source enclosure are disposed such that a slot is defined there-between; and the slot formed between the front end surface of the electric enclosure and distal end surface of the light source enclosure is a heat isolation slot.

4. The high power LED lighting fixture according to claim 3, wherein an insulation sheet is disposed in the heat isolation gap.

5. The high power LED lighting fixture according to claim 4, wherein one surface of the insulation sheet contacts the front end surface of the electric enclosure, while the other surface thereof contacts the distal end surface of the light source enclosure.

6. The high power LED lighting fixture according to claim 1, wherein a groove is defined in the front end of the electric enclosure, and a protrusion is formed on the distal end of the light source enclosure; and the protrusion is inserted into the groove so as to realize bayonet connection between the electric enclosure and light source enclosure.

7. The high power LED lighting fixture according to claim 6, wherein a screw is placed between the front end surface of the electric enclosure and distal end surface of the light source enclosure; and the screw passes through the front end surface of the electric enclosure and distal end of the light source enclosure and then locks the two together.

8. The high power LED lighting fixture according to claim 7, wherein the screw may be a hollow metal screw.
